(19) United States
(12) Patent Application Publication
(10) Pub. No.: US 2025/0066939 A1
(43) Pub. Date: Feb. 27, 2025

(54) System and Method for Delivery of Thermal Energy for Hydrogen (H2) Gas Production

(71) Applicant: Future Energy LLC, Houston, TX (US)

(72) Inventor: Kent B. Hytken, Houston, TX (US)

(73) Assignee: Future Energy LLC, Houston, TX (US)

(21) Appl. No.: 18/813,154

(22) Filed: Aug. 23, 2024

Related U.S. Application Data
(60) Provisional application No. 63/578,374, filed on Aug. 24, 2023.

(51) Int. Cl. C25B 15/02; C25B 1/04

(52) U.S. Cl. CPC C25B 15/02; C25B 1/04

(57) ABSTRACT

A system and method for thermal energy delivery for hydrogen (H₂) gas production is disclosed. The method involves generating electricity via a solar plant and providing it to a hydrogen electrolyzer. Thermal energy from the solar plant is used to heat a primary working fluid, which transfers heat to a secondary working fluid in an evaporator, converting it into vapor. This vaporized secondary working fluid drives a turbine, generating electricity through a Rankine cycle system where the secondary working fluid circulates continuously, transmitting the secondary working fluid and a portion of the generated electricity to the hydrogen electrolyzer, which splits the secondary working fluid into H₂ gas and oxygen, storing the H₂ gas in a hydrogen gas storage tank. When solar power is unavailable, the stored electricity in the battery energy storage is supplied to the electrolyzer.

### CROSS-REFERENCE TO RELATED APPLICATION

The present non-provisional application claims the benefit of priority to provisional patent application No. 63/578,374 filed on Aug. 24, 2023, entitled “SYSTEMS AND METHODS FOR DELIVERY OF THERMAL ENERGY FOR H₂ PRODUCTION” the entire contents of which are hereby expressly incorporated by reference.

### FIELD OF THE INVENTION

The present invention relates to a system and method for delivering thermal energy for H₂ gas production by separating hydrogen and oxygen molecules from water.

### BACKGROUND OF THE INVENTION

Hydrogen gas is a colorless, odorless, and flammable gaseous substance that can be utilized as a clean fuel in a manner that the combustion of hydrogen gas generates only water vapor and does not produce carbonaceous pollutants and greenhouse gases. Hydrogen gas can power vehicles designed to use hydrogen gas as a combustible alternative to gasoline or diesel. In addition, hydrogen can be used in electric vehicles (EVs) based on hydrogen fuel cells. These electric vehicles use hydrogen gas stored in onboard tanks to generate electricity through a chemical process called fuel cell electrochemistry. Hydrogen gas from the tank reacts with oxygen from the air in a fuel cell stack, producing electricity, water vapor, and heat as byproducts. Further, hydrogen gas can be used for power generation in power plants. Hydrogen gas is also a reducing agent and can be used in ammonia-based industrial applications, steel manufacturing, concrete production, or oil refineries. Due to its lightweight, hydrogen gas can also be used as a zero-emission aviation fuel.

Hydrogen gas is produced through the electrolysis process. Electricity is required to operate the electrolysis process. Different renewable sources, such as wind and solar, can generate the necessary electricity. Also, producing hydrogen gas with zero-emission and low cost is challenging as the traditional system is not eco-friendly and operates at a high price. In the case of non-renewable sources of generating electricity, the emissions directly affect the environment and consume a lot of energy. In the case of conventional systems with renewable sources, the efficiency of generating electricity is relatively very low compared to desired levels.

Therefore, there is a need in the art for a system and method of producing hydrogen gas that does not suffer from the deficiencies above.

### OBJECTS OF THE INVENTION

Some of the objects of the invention are as follows:

An object of the present invention is to develop a system that generates hydrogen gas by utilizing energy from renewable resources.

Another object of the present invention is to develop a system capable of generating electricity using thermal energy from solar irradiances.

Another object of the present invention is to develop a system capable of generating hydrogen gas during daytime and nighttime hours.

Another object of the present invention is that the desired system for generating hydrogen gas be eco-friendly.

Yet another object of the present invention is to develop an energy-efficient and relatively economical hydrogen production system.

### SUMMARY OF THE INVENTION

The present invention is related to a system and method for thermal energy delivery for hydrogen (H₂) gas production capable of generating hydrogen gas by utilizing electricity from renewable energy sources.

According to an embodiment of the present invention, a method is provided to deliver thermal energy for hydrogen (H₂) gas production. The method may include providing electricity from a solar plant to a hydrogen electrolyzer. The method may include utilizing thermal energy from the solar plant to heat a primary working fluid. The method may include transferring heat from the primary working fluid to a secondary working fluid in an evaporator, thereby converting the secondary working fluid to a vaporized secondary working fluid. The method may include utilizing the vaporized secondary working fluid to rotate a turbine and generate electricity through a Rankine cycle system. In an embodiment throughout the Rankine cycle system, the secondary working fluid and the vaporized secondary working fluid continuously circulate. The method may include transmitting the secondary working fluid to the hydrogen electrolyzer. The method may include transferring some of the generated electricity to the hydrogen electrolyzer. The method may include storing a remaining portion of the generated electricity in a battery energy storage unit. The method may provide electricity from the battery energy storage unit to the hydrogen electrolyzer when the solar plant cannot generate electricity directly. The method may include producing H₂ gas in the hydrogen electrolyzer by splitting the secondary working fluid into the H2gas and oxygen. The method may include storing the produced H₂ gas in a hydrogen gas storage tank.

According to an embodiment of the present invention, a system for delivering thermal energy for hydrogen (H2) gas production is provided. The system may include a solar plant configured to generate electricity. The system may consist of a Rankine cycle system configured to generate electricity from thermal energy. In an embodiment, the Rankine cycle system may consist of an evaporator configured to transfer heat from a primary working fluid to a secondary working fluid, causing the secondary working fluid to vaporize, thereby converting the secondary working fluid to a vaporized secondary working fluid. The Rankine cycle system may include a turbine configured to be rotated by the vaporized secondary working fluid to produce electricity. In an embodiment throughout the Rankine cycle system, the secondary working fluid and the vaporized secondary working fluid continuously circulate. The system may include a hydrogen electrolyzer configured to produce H₂ gas by splitting the secondary working fluid into the H2 gas and oxygen, using the electricity generated by the solar plant. The system may include a battery energy storage unit configured to store electricity generated by the Rankine cycle system and provide the stored electricity in battery energy storage to the hydrogen electrolyzer when the solar plant cannot generate electricity. The system may include a hydrogen gas storage tank configured to store hydrogen gas produced by the hydrogen electrolyzer.

### BRIEF DESCRIPTION OF DRAWINGS

The accompanying drawings illustrate the best mode for carrying out the invention as contemplated and set forth hereinafter. The present invention may be more clearly understood from a consideration of the following detailed description of the preferred embodiments taken in conjunction with the accompanying drawings wherein reference letters and numerals indicate the corresponding parts in various figures in the accompanying drawings, and in which:

FIG. 1 illustrates a schematic view of a system for the delivery of thermal energy for H₂ production with an electric heat exchanger in accordance with an embodiment of the present invention;

FIG. 2 illustrates a flow diagram of the system for delivery of thermal energy for H₂ production with the electric heat exchanger of FIG. 1, in accordance with an embodiment of the present invention;

FIG. 3 illustrates a schematic view of a system for the delivery of thermal energy for H₂ production, in accordance with another embodiment of the present invention; and

FIG. 4 illustrates a flow diagram of the system for thermal energy delivery for H₂ production of FIG. 3, in accordance with another embodiment of the present invention.

### DETAILED DESCRIPTION OF THE INVENTION

Embodiments of the present invention disclosure will be described more fully hereinafter with reference to the accompanying drawings, which represent elements throughout the figures and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made without departing from the spirit or scope of the present disclosure. The following detailed description is not to be taken in a limiting sense.

The present invention proposes a system and method for the delivery of thermal energy for H₂ production (hereinafter referred to as “hybrid hydrogen production system” or “HHPS”) that includes at least one heat exchanger is thermally connected to each one of the solar panels. Moreover, each of the solar panels has been provided with a tracking device that allows the solar panels to follow the movement of the sun relative to the earth to maximize absorption of solar energy or irradiance. The solar plant is used herein to convert the electromagnetic radiation received from the sun to electrical energy and thermal energy. Further, a hydrogen electrolyzer is electrically linked with the solar plant to produce hydrogen gas by utilizing the electrical energy converted directly from the solar irradiance. Further, a primary working fluid (for example, water, oil, or a refrigerant) flows within the heat exchangers. The primary working fluid is heated up to a first design temperature (for example, ˜170° F.) by utilizing the thermal energy from the solar plant. The primary working fluid, heated up to the design temperature, then flows towards an electric heat exchanger, which is associated with the hybrid hydrogen production system to heat the primary working fluid, due to which the temperature of the primary working fluid reaches up to a higher second design temperature (for example, ˜300° F.).

Further, a primary two-way valve is installed at the exit of the solar plant. Once the primary working fluid is heated up to the first design temperature, the two-way valve will close to restrict the return of the primary working fluid back into the heat exchanger(s). While the primary two-way valve is closed, a secondary two-way valve is configured before the inlet of the solar plant opens to enable the primary working fluid to flow towards the inlet of heat exchanger(s) of the solar plant. Further, to avoid the phase change of the primary working fluid from liquid to vapor/steam, a primary working fluid pump is installed before the electric heat exchanger, which maintains a first minimum design pressure (for example, ˜65 psi) of the primary working fluid. Further, a Rankine cycle system is associated with the hybrid hydrogen production system. The Rankine cycle system includes an evaporator, a turbine, a condenser, and a secondary working fluid pump. A secondary working fluid flows in the Rankine cycle system in the liquid and the vapor phase.

Further, the primary working fluid with the second design temperature, after exiting the electric heat exchanger, is passed through the evaporator in a manner so that the secondary working fluid inside the evaporator extracts the heat from the primary working fluid, which results in a decrease in the temperature of the primary working fluid from the second design temperature and increase in temperature of the secondary working fluid. The primary working fluid then encounters a preheater associated with the Rankine cycle system, where the primary working fluid further rejects heat to the secondary working fluid to increase the temperature of the secondary working fluid before the secondary working fluid enters the evaporator. The secondary working fluid exits the evaporator in the vapor phase because it is heated beyond the boiling point temperature of the secondary working fluid, as the secondary working fluid extracts the heat from the primary working fluid.

The secondary working fluid in the vapor phase then expands within the turbine, causing it to rotate. Further, a generator is electrically connected to the turbine through a shaft. Due to the turbine's rotation, the shaft rotates, generating a magnetic field inside the generator that produces electricity.

Further, the expanded vaporized secondary working fluid is passed through the condenser. The condenser extracts the heat from the vaporized secondary working fluid. It transfers the extracted heat to a tertiary working fluid at a lower temperature than the secondary working fluid. The tertiary working fluid then flows through a radiator, which is associated with the Rankine cycle system and rejects the excessive heat to the environment. Furthermore, upon extracting the heat from the vaporized secondary working fluid, the temperature of the vaporized secondary working fluid is reduced, which changes the phase of the secondary working fluid from the vaporized phase to the liquid phase. Further, the secondary working fluid in the liquid phase is then passed through the secondary working fluid pump to increase the pressure of the secondary working fluid in the liquid phase and transfer the high-pressure secondary working fluid to the evaporator through the preheater.

While some of the generated electricity is stored in a battery energy storage unit associated with the hybrid hydrogen production system, some electricity is directly supplied to the hydrogen electrolyzer through a capacitor bank, which is electrically connected before the hydrogen electrolyzer. The battery energy storage unit stores the electricity and provides it to the hydrogen electrolyzer at nighttime or whenever needed. Once the hydrogen gas is produced, the gas is stored within a gas storage tank, which is fluidically connected to the hydrogen electrolyzer.

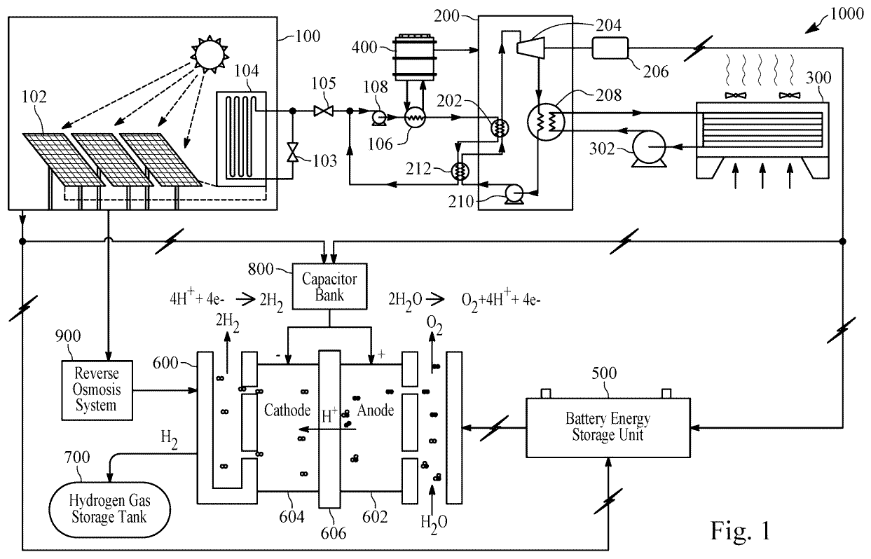

Several embodiments of the present invention will now be elucidated with the help of FIGS. 1-4.

FIG. 1 illustrates a schematic view of the system 1000 for delivery of thermal energy for H₂ production (hereinafter also referred to as “hybrid hydrogen production system 1000”) with an electric heat exchanger 106, in accordance with an embodiment of the present invention. The hybrid hydrogen production system 1000 was developed to generate hydrogen gas by utilizing electricity from renewable energy sources with zero emissions. In several embodiments of the invention, a hydrogen electrolyzer 600 is associated with the hybrid hydrogen production system 1000. It is developed to generate hydrogen gas by separating oxygen molecules and hydrogen molecules from water molecules. The hydrogen electrolyzer 600 receives the supply of electricity directly from solar plant 100 and the battery energy storage unit 500, which are associated with the hybrid hydrogen production system 1000.

In several embodiments of the invention, the hydrogen electrolyzer 600 includes an electrolyte 606 and a pair of electrodes, i.e., an anode 602 and a cathode 604. The electrolyte 606 enables the ions to flow and facilitates the electrolysis process. Further, the anode 602 is electrically connected to the positive terminals of the solar plant 100 and the battery energy storage unit 500. Furthermore, the cathode 604 is electrically connected to the negative terminals of the solar plant 100 and the battery energy storage unit 500. Further, an optimum amount of clean or distilled water is supplied to the electrolyzer 600 to produce hydrogen gas from the water molecules. Additionally, water circulated within each solar panel 102 of the solar plant 100 to reduce irradiated heat is transmitted to a reverse osmosis system 900 for deionizing or demineralizing the water. The deionized or demineralized water is then transmitted to the hydrogen electrolyzer 600 to produce hydrogen gas. Upon supply of the electricity to the hydrogen electrolyzer 600, at the anode 602, the oxidation, i.e., loss of electrons, occurs. The water molecules release oxygen gas and positively charged hydrogen ions, as described by the chemical equation (1).

$$2 {H}_{2} O \to 4 {H}^{+} + {O}_{2} + 4 {e}^{-} \qquad ( 1 )$$

Further, at the cathode 604, reduction, i.e., gain of electrons. At the cathode 604, the positively charged hydrogen ions combine with the electrons from the electric current to produce hydrogen gas, as represented through chemical equation (2).

$$4 {H}^{+} + 4 {e}^{-} \to 2 {H}_{2} \qquad ( 2 )$$

The overall reaction is represented by chemical equation (3).

$$2 {H}_{2} O \to 2 {H}_{2} + {O}_{2} \qquad ( 3 )$$

In several embodiments of the invention, the solar plant 100 includes a plurality of heat exchangers 104 and a plurality of solar panels 102. Each of the panels 102 is oriented so that solar irradiance directly strikes the solar panels 102. To maximize the effectiveness of the incidence of solar irradiance on solar panels 102, each of the solar panels 102 is configured with solar tracking devices. Due to the solar tracking devices, each solar panel 102 moves according to the sun's movement. During the day, solar panel 102 can extract the maximum energy from solar irradiance. Further, the energy extracted by the solar panels 102 is converted into electricity supplied to the hydrogen electrolyzer 600 for producing hydrogen gas.

Further, each solar panel 102 is configured with at least one of the pluralities of heat exchanger 104 in which a primary working fluid flows. In several embodiments of the invention, the working fluid is water, oil, or refrigerant. In several embodiments of the invention, the solar panels 102, while meeting the solar irradiances, also absorb thermal energy utilized to heat the primary working fluid through conduction and convection heat transfer mode. Due to thermal energy, the temperature of the primary working fluid is increased up to a first predetermined temperature (for example, ˜170° F.). The primary working fluid with the first predetermined temperature then flows from the solar panels plurality of heat exchangers 104 to the electric heat exchanger 106, which is associated with the hybrid hydrogen production system 1000, via a primary two-way valve 105, for increasing the temperature of the primary working fluid from the first predetermined temperature to a second predetermined temperature (for example, from ˜170° F. to ˜300° F.). Once the primary working fluid with the first predetermined temperature crosses the primary two-way valve 105, the primary two-way valve 105 will close. Simultaneously, a secondary two-way valve 103 (as shown in FIG. 1) is opened to enable the further flow of the primary working fluid towards the heat exchanger 104 through the secondary two-way valve 103.

Further, the pressure of the primary working fluid with the first predetermined temperature is increased by a primary working fluid pump 108 arranged between the primary two-way valve 105 and the electric heat exchanger 106. The pressure of the primary working fluid is maintained higher than the first minimum pressure (for example, ˜65 psi) to eliminate the chance of the primary working fluid's phase change from liquid to vapor after leaving the electric heat exchanger 106.

In several embodiments of the invention, the hybrid hydrogen production system 1000 includes a Rankine cycle system 200, which consists of an evaporator 202, a turbine 204, a condenser 208, and a secondary working fluid pump 210. Further, after exiting the electric heat exchanger 106, the primary working fluid at the second predetermined temperature encounters the evaporator 202, where the primary working fluid at the second predetermined temperature transfers the heat to a secondary working fluid, which flows inside the Rankine cycle system 200. The heat transfer between the primary working fluid and the secondary working fluid occurs through conduction and convection modes of heat transfer. Further, the secondary working fluid leaves the evaporator 202 in the vapor/steam or liquid phase. The secondary working fluid in the vaporized or liquid state then strikes with the plurality of blades of the turbine 204. Due to the striking of the secondary working fluid with the blades of the turbine 204, the turbine 204 rotates, and the secondary working fluid expands. Further, the turbine 204 is connected with a generator 206 through a shaft. Due to the rotation of the turbine 204, the shaft rotates, and hence the generator 206 generates the electricity.

Further, the secondary working fluid passes through the condenser 208 after expansion. In condenser 208, the temperature of the secondary working fluid is reduced to change the phase of the secondary working fluid from vapor to liquid. The temperature of the secondary working fluid herein is diminished as the secondary working fluid rejects the heat to the atmosphere through a radiator 300, associated with the Rankine cycle system 200. In the radiator 300, a tertiary working fluid flows, which extracts the heat from the secondary working fluid and releases the heat to the environment through the radiator 300. Herein, the flow is maintained by a tertiary working fluid pump 302, installed in pressure of the tertiary working fluid maintained by tertiary working fluid pump 302, which is installed between the condenser 208 and the radiator 300. Further, the secondary working fluid in the liquid phase, after leaving the condenser 208, is pumped towards the evaporator 202 via a preheater 212 associated with the hybrid hydrogen production system 1000 through the secondary working fluid pump 210.

In the preheater 212, the temperature of the secondary working fluid is increased due to the extraction of the heat from the primary working fluid. After that, the process repeats continuously to generate electricity. Further, some electricity is stored in the battery energy storage unit 500. In contrast, some electricity is directly provided to the hydrogen electrolyzer 600 through a capacitor bank 800, associated with the hybrid hydrogen production system 1000. In several embodiments of the invention, excess electrical energy generated by the solar plant 100, which is not required by the hydrogen electrolyzer 600, is also stored in the battery energy storage unit 500. In several embodiments of the invention, when the hydrogen electrolyzer 600 is under maintenance or not in use, then the electrical energy generated by the solar plant 100 is stored in the battery energy storage unit 500. In several embodiments of the invention, the capacitor bank 800 voltages, storing the electricity at different voltages from the solar plant 100 and the Rankine cycle system 200. Per the required voltage and power, the capacitor bank 800 provides electricity to the hydrogen electrolyzer 600. Further, the battery energy storage unit 500 stores the electricity and provides the electricity to the hydrogen electrolyzer 600 at nighttime or whenever needed. Once the hydrogen gas is produced, the gas is stored within a hydrogen gas storage tank 700, connected to the hydrogen electrolyzer 600.

Additionally, the system 1000 includes a geothermal energy storage 400 that repurposes underground geological formations such as salt caverns, depleted petroleum reservoirs, and any underground cavern into geothermal power plants that can store renewable energy underground for weeks or months instead of converting it to electricity and storing it for several hours in a surface battery energy storage system (BESS). Solar energy heats hot water from oil reservoirs, aquifers, groundwater, or potable water piped to the site. The hot water or primary working fluid generates geothermal energy stored in underground geological formations. Each solar panel includes at least one heat exchanger 106 that heats a primary working fluid, water, which flows within the heat exchangers. Alternatively, the solar panels could be conventional flat or parabolic without heat exchangers.

The solar energy heats the primary working fluid to a first design temperature (for example, ˜170° F.) by utilizing the thermal energy from the solar plant. The primary working fluid, heated to the design temperature, flows towards the electric heat exchanger 106, increasing the temperature of the primary working fluid from the first predetermined temperature to a second predetermined temperature (for example, from ˜170° F. to ˜800° F.). The pressure of the primary working fluid is maintained higher than the first minimum pressure (for example, ˜65 psi) to eliminate the chance of the primary working fluid's phase change from liquid to vapor after leaving the electric heat exchanger 106. The primary hot working fluid is stored in an underground geological formation. When electricity is required, the hot geothermal working fluid stored in the underground geological formation is brought to the surface in a closed-loop system where the hot geothermal working fluid enters the electric heat exchanger 106, is reheated at least at 300° F. before entering the Rankine cycle system 200, which consists of the evaporator 202, the turbine 204, the condenser 208, and the secondary working fluid pump 210.

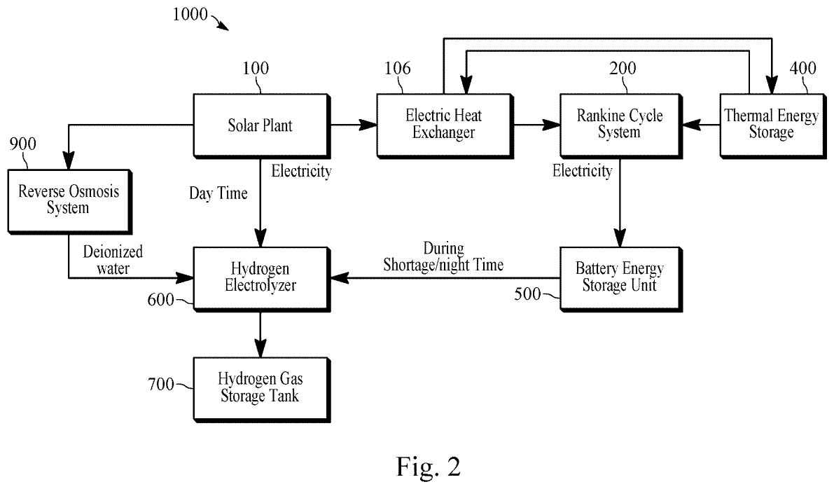

Further, the geothermal working fluid encounters the evaporator 202, where the geothermal working fluid flows inside the Rankine cycle system 200. Further, the geothermal working fluid leaves the evaporator 202 in the vapor/steam or liquid phase. The geothermal working fluid in the vaporized or liquid state then strikes with the plurality of turbine blades 204. Due to the striking of the geothermal working fluid with the blades of the turbine 204, the turbine 204 rotates, and the geothermal working fluid expands. Further, the turbine 204 relates to the generator 206 through a shaft. Due to the rotation of the turbine 204, the shaft rotates; hence, the generator 206 generates kilowatts or megawatts of electricity. The on-site electricity generation can flow to an on-site substation, and kilowatts or megawatts of electricity can be delivered or wheeled to the utility electric grid. FIG. 2 illustrates a flow diagram of system 1000 for the thermal energy delivery for H₂ production with the electric heat exchanger 106 of FIG. 1, in accordance with an embodiment of the present invention. In FIG. 2, the solar plant 100 provides electricity to the hydrogen electrolyzer 600. In the first way, the solar plant 100 directly provides the electricity to the hydrogen electrolyzer 600. In the second way, the solar plant 100 provides the thermal energy to the Rankine cycle system 200, which generates the electricity. The primary working fluid extracts the heat from the thermal energy, which increases the temperature of the primary working fluid up to the first predetermined temperature. Further, the primary working fluid is passed through the electric heat exchanger 106, where the temperature of the primary working fluid is increased up to the second predetermined temperature, which is utilized to raise the temperature of the secondary working fluid. The secondary working fluid rotates turbine 204, producing the work used to generate electricity. Further, some generated electricity via the Rankine cycle system 200 is provided to the hydrogen electrolyzer 600. In contrast, some of the generated electricity via the Rankine cycle system 200 is stored in the battery energy storage unit 500, which further provides electricity to the hydrogen electrolyzer 600 when the solar plant 100 cannot generate the electricity directly.

Additionally, the system 1000 includes a geothermal energy storage 400 that repurposes underground geological formations such as salt caverns, depleted petroleum reservoirs, and any underground cavern into geothermal power plants that can store renewable energy underground for weeks or months instead of converting it to electricity and storing it for several hours in a surface battery energy storage system (BESS). Solar energy heats hot water from oil reservoirs, aquifers, groundwater, or potable water piped to the site. The hot water or primary working fluid generates geothermal energy stored in underground geological formations. Each solar panel includes at least one heat exchanger 106 that heats a primary working fluid, water, which flows within the heat exchangers. Alternatively, the solar panels could be conventional flat or parabolic without heat exchangers.

The solar energy heats the primary working fluid to a first design temperature (for example, ˜170° F.) by utilizing the thermal energy from the solar plant. The primary working fluid, heated to the design temperature, flows towards the electric heat exchanger 106, increasing the temperature of the primary working fluid from the first predetermined temperature to a second predetermined temperature (for example, from ˜170° F. to ˜800° F.). The pressure of the primary working fluid is maintained higher than the first minimum pressure (for example, ˜65 psi) to eliminate the chance of the primary working fluid's phase change from liquid to vapor after leaving the electric heat exchanger 106. The primary hot working fluid is stored in an underground geological formation. When electricity is required, the hot geothermal working fluid stored in the underground geological formation is brought to the surface in a closed-loop system where the hot geothermal working fluid enters the electric heat exchanger 106, is reheated at least at 300° F. before entering the Rankine cycle system 200, which consists of the evaporator 202, the turbine 204, the condenser 208, and the secondary working fluid pump 210.

Further, the geothermal working fluid encounters the evaporator 202, where the geothermal working fluid flows inside the Rankine cycle system 200. Further, the geothermal working fluid leaves the evaporator 202 in the vapor/steam or liquid phase. The geothermal working fluid in the vaporized or liquid state then strikes with the plurality of turbine blades 204. Due to the striking of the geothermal working fluid with the blades of the turbine 204, the turbine 204 rotates, and the geothermal working fluid expands. Further, the turbine 204 relates to the generator 206 through a shaft. Due to the rotation of the turbine 204, the shaft rotates; hence, the generator 206 generates kilowatts or megawatts of electricity. The on-site electricity generation can flow to an on-site substation, and kilowatts or megawatts of electricity can be delivered or wheeled to the utility electric grid.

Additionally, water circulated within each solar panel 102 of the solar plant 100 to reduce irradiated heat is transmitted to a reverse osmosis system 900 for deionizing or demineralizing the water. The deionized or demineralized water is then transmitted to the hydrogen electrolyzer 600 to produce hydrogen gas. Once the hydrogen electrolyzer 600 produces the hydrogen gas, the hydrogen gas is then stored within the hydrogen gas storage tank 700.

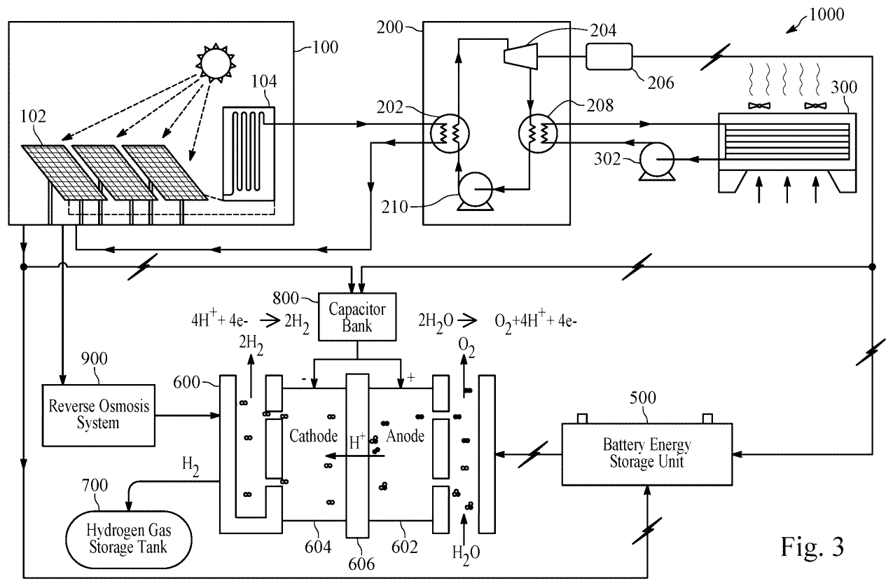

FIG. 3 illustrates a schematic view of the system 1000 for thermal energy delivery for H₂ production, in accordance with another embodiment of the present invention. The hybrid hydrogen production system 1000 was designed to generate hydrogen gas using electricity from renewable energy sources, making zero emissions. In several embodiments of the invention, the hydrogen electrolyzer 600 is developed to generate hydrogen gas by separating the oxygen from water molecules. The hydrogen electrolyzer 600 receives the supply of electricity directly from the solar plant 100 and the battery energy storage unit 500. Additionally, water circulated within each solar panel 102 of the solar plant 100 to reduce irradiated heat is transmitted to a reverse osmosis system 900 for deionizing or demineralizing the water. The deionized or demineralized water is then transmitted to the hydrogen electrolyzer 600 to produce hydrogen gas

In several embodiments of the invention, the hydrogen electrolyzer 600 further includes the electrolyte 606 and the pair of electrodes 602 and 604, i.e., the anode 602 and the cathode 604. The electrolyte 606 enables the ions to flow and facilitates the electrolysis process. Further, the anode 602 is connected with the positive terminals of the solar plant 100 and the positive terminals of the battery energy storage unit 500. Furthermore, the cathode 604 is connected with the negative terminal of the solar plant 100 and the negative terminals of the battery energy storage unit 500. Further, an optimum amount of water is supplied to the hydrogen electrolyzer 600 to produce the hydrogen gas from the water molecules. This water is deionized or demineralized through the reverse osmosis system 900. Upon supply of the electricity to the hydrogen electrolyzer 600, at the anode 602, the oxidation, i.e., loss of electrons, occurs as represented by the chemical equation (1). The water molecules release the oxygen gas and the positively charged ions at the cathode 604, reducing, i.e., a gain of electrons. At the cathode 604 electrode, the positively charged hydrogen ions combine with the electrons from the electric current to produce hydrogen gas, as represented by the chemical equation (2).

In several embodiments of the invention, the solar plant 100 includes the plurality of heat exchangers 104 and the plurality of solar panels 102. Each of the solar panels 102 is oriented so that the solar irradiance directly strikes the solar panels 102. To maximize the effectiveness of the incidence of solar irradiance on solar panels 102, each of the solar panels 102 is configured with a solar tracking feature. Due to the solar tracking feature, each of the solar panels 102 moves according to the sun's movement so that during the whole day, the solar panels 102 can extract the maximum energy from the solar irradiance. Further, the energy extracted by the solar panels 102 is converted into electricity supplied to the hydrogen electrolyzer 600 for producing hydrogen gas.

Further, each solar panel 102 is configured with the heat exchanger 104 while encountering solar irradiance, absorbing thermal energy, which the primary working fluid flows. In several embodiments of the invention, the solar panels 102, while encountering the solar irradiance, also absorb thermal energy, which is utilized to heat the primary working fluid through conduction and convection heat transfer mode. Due to thermal energy, the temperature of the primary working fluid is increased up to the first predetermined temperature.

In several embodiments of the invention, the hybrid hydrogen production system 1000 includes the Rankine cycle system 200, which consists of the evaporator 202, the turbine 204, the condenser 208, and the secondary working fluid pump 210. Further, after exiting the primary working fluid from the heat exchangers, the primary working fluid encounters the evaporator 202, where the primary working fluid at the first predetermined temperature transfers the heat to a secondary working fluid flows inside the Rankine cycle system 200. The heat transfer between the primary and the secondary working fluids occurs through the conduction and convection modes of heat transfer. Further, the secondary working fluid is selected in a manner that the boiling point temperature of the secondary working fluid is below the first predetermined temperature so that when the primary working fluid with the first predetermined temperature encounters the secondary working fluid, the phase of the secondary working fluid changes from liquid to vapor at a temperature less than the first predetermined temperature. Further, the secondary working fluid leaves the evaporator 202 in the vapor/steam or liquid phase. The secondary working fluid in the vaporized state then strikes with the plurality of blades of the turbine 204. Due to the striking of the secondary working fluid with the blades of the turbine 204, the turbine 204 rotates and expands the secondary working fluid. Further, the turbine 204 is connected with the generator 206 through the shaft. Due to the rotation of turbine 204, the shaft rotates, and generator 206 generates the electricity.

Further, the secondary working fluid passes through the condenser 208 upon expansion. In condenser 208, the temperature of the secondary working fluid is reduced to change the phase of the secondary working fluid from vapor to liquid. The temperature of the secondary working fluid herein is reduced by rejecting the heat to the atmosphere through the radiator 300, which is associated with the Rankine cycle system 200. In the radiator 300, the tertiary working fluid flows, extracting the heat from the secondary working fluid, and releasing the heat to the environment through the radiator 300. Herein, the flow and the pressure of the tertiary working fluid are maintained by the tertiary working fluid pump 302. Further, the secondary working fluid in the liquid phase, after leaving the condenser 208, is pumped towards the evaporator 202 through the secondary working fluid pump 210. After that, the process of generating electricity is constantly repeated.

Further, some electricity is stored in the battery energy storage unit 500. In contrast, some electricity is directly provided to the hydrogen electrolyzer 600 through the capacitor bank 800, which is associated with the hybrid hydrogen production system 1000. In several embodiments of the invention, excess electrical energy generated by the solar plant 100, which is not required by the hydrogen electrolyzer 600, is also stored in the battery energy storage unit 500. In several embodiments of the invention, when the hydrogen electrolyzer 600 is under maintenance or not in use, then the electrical energy generated by the solar plant 100 is stored in the battery energy storage unit 500. In several embodiments of the invention, the capacitor bank 800 stores the electricity at different voltages from the solar plant 100 and the Rankine cycle system 200. Per the required voltage and power, the capacitor bank 800 provides electricity to the hydrogen electrolyzer 600. Further, the battery energy storage unit 500 stores the electricity and provides the electricity to the hydrogen electrolyzer 600 at nighttime or whenever needed. Once the hydrogen gas is produced, it is stored within the hydrogen gas storage tank 700, which is fluidically connected to the hydrogen electrolyzer 600.

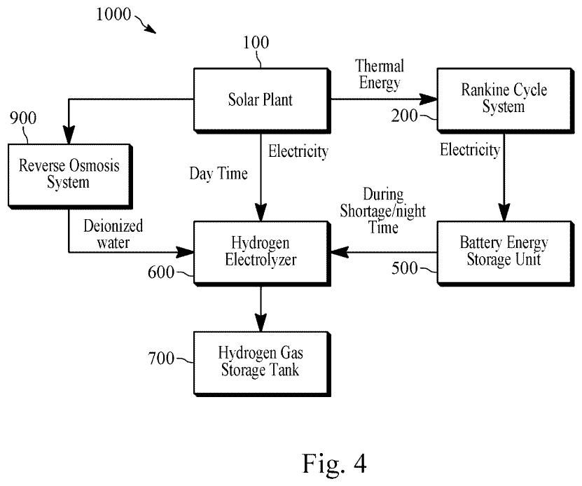

FIG. 4 illustrates a flow diagram of system 1000 for thermal energy delivery for H₂ production, in accordance with another embodiment of the present invention. In FIG. 4, the solar plant 100 provides electricity to the hydrogen electrolyzer 600. In the first way, the solar plant 100 directly provides the electricity to the hydrogen electrolyzer 600. In the second way, the solar plant 100 provides the thermal energy to the Rankine cycle system 200, which generates the electricity. Further, the primary working fluid extracts the heat from the thermal energy, which increases the temperature of the primary working fluid up to the first predetermined temperature. Further, the primary working fluid is passed through the evaporator 202, where the secondary working fluid flows. The secondary working fluid extracts the heat from the primary working fluid, so the phase of the secondary working fluid changes from liquid to vapor, which rotates the turbine 204 that produces the work, which is utilized to generate electricity. Further, some generated electricity via the Rankine cycle system 200 is provided to the hydrogen electrolyzer 600. In contrast, some of the generated electricity via the Rankine cycle system 200 is stored in the battery energy storage unit 500, which further provides electricity to the hydrogen electrolyzer 600 when the solar plant 100 cannot generate the electricity directly. Additionally, water circulated within each solar panel 102 of the solar plant 100 to reduce irradiated heat is transmitted to a reverse osmosis system 900 for deionizing or demineralizing the water. The deionized or demineralized water is then transmitted to the hydrogen electrolyzer 600 to produce hydrogen gas. Once the hydrogen electrolyzer 600 produces the hydrogen gas, the hydrogen gas is then stored within the hydrogen gas storage tank 700.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other alternatives, modifications, and variations that fall within the scope of the present invention.

1. A method for delivery of thermal energy for hydrogen (H₂) gas production, the method comprising:
providing electricity generated by a solar plant to a hydrogen electrolyzer;
utilizing thermal energy from the solar plant to heat a primary working fluid;
transferring heat from the primary working fluid to a secondary working fluid in an evaporator, thereby converting the secondary working fluid to a vaporized secondary working fluid;
utilizing the vaporized secondary working fluid to rotate a turbine and generate electricity through a Rankine cycle system;
circulating water within each solar panel of the solar plant to reduce irradiated heat, thereby increasing the longevity of solar cells and the lifespan of each of the solar panels of the solar plant
transmitting the water from the solar plant to a reverse osmosis system for deionizing or demineralizing the water;
transmitting the deionized or demineralized water from the reverse osmosis system to the hydrogen electrolyzer to produce H₂ gas;
transmitting a portion of the generated electricity to the hydrogen electrolyzer;
storing a remaining portion of the generated electricity in a battery energy storage unit;
providing electricity from the battery energy storage unit to the hydrogen electrolyzer when the solar plant is unable to generate electricity directly;
producing H₂ gas in the hydrogen electrolyzer by splitting the secondary working fluid into the H₂ gas and oxygen; and
storing the produced H₂ gas in a hydrogen gas storage tank.

2. The method of claim 1, further comprising:
monitoring the availability of electricity generated by the solar plant;
automatically switching the source of electricity to the hydrogen electrolyzer from direct solar electricity to the battery energy storage unit during periods when the solar plant is not generating electricity.

3. The method of claim 1, wherein the primary working fluid is heated to a first predetermined temperature before transferring heat to the secondary working fluid.

4. The method of claim 1, wherein the secondary working fluid is selected from a group consisting of water, organic Rankine cycle fluids, and refrigerants.

5. The method of claim 1, wherein the battery energy storage unit is charged using excess electricity generated by the Rankine cycle system.

6. A system for delivery of thermal energy for hydrogen (H₂) gas production, comprising:
a solar plant configured to generate electricity;
a Rankine cycle system configured to generate electricity from thermal energy, wherein the Rankine cycle system includes:
an evaporator configured to transfer heat from a primary working fluid to a secondary working fluid, causing the secondary working fluid to vaporize, thereby converting the secondary working fluid to a vaporized secondary working fluid;
a turbine configured to be rotated by the vaporized secondary working fluid to produce electricity,
a mechanism for circulating water within each solar panel of the solar plant to reduce irradiated heat, thereby increasing the longevity of solar cells and the lifespan of each solar panel of the solar plant,
wherein the mechanism further transmits the water from the solar plant to a reverse osmosis system for deionizing or demineralizing the water,
wherein the mechanism further transmits the deionized or demineralized water from the reverse osmosis system to a hydrogen electrolyzer;
wherein the hydrogen electrolyzer is electrically coupled with the solar plant, wherein the hydrogen electrolyzer is configured to produce H₂ gas by splitting the deionized or demineralized water into the H₂ gas and oxygen, using the electricity generated by the solar plant;
a battery energy storage unit electrically coupled with the Rankine cycle system, wherein the battery energy storage unit is configured to store electricity generated by the Rankine cycle system and provide the stored electricity to the hydrogen electrolyzer when the solar plant is unable to generate electricity; and
a hydrogen gas storage tank configured to store hydrogen gas produced by the hydrogen electrolyzer.

7. The system of claim 6, wherein the solar plant is configured to provide thermal energy to heat the primary working fluid.

8. The system of claim 6, further comprising:
a control system configured to monitor the availability of electricity generated by the solar plant and automatically switch the source of electricity to the hydrogen electrolyzer from the solar plant to the battery energy storage unit during periods when the solar plant is not generating electricity.

9. The system of claim 6, wherein the primary working fluid is selected to be heated to a first predetermined temperature before transferring heat to the secondary working fluid.

10. The system of claim 6, wherein the secondary working fluid is selected from a group consisting of water, organic Rankine cycle fluids, and refrigerants.

11. The system of claim 6, wherein the battery energy storage unit is configured to be charged using excess electricity generated by the Rankine cycle system.
